(19) United States
(12) Patent Application Publication
(10) Pub. No.: US 2024/0424865 A1
(43) Pub. Date: Dec. 26, 2024

(54) Blower, Ventilation Device, Vehicle Seat or Battery System, Manufacturing Method and Equipment

(71) Applicant: Gentherm GmbH, Odelzhausen (DE)

(72) Inventor: Rong Dai, Shanghai (CN)

(21) Appl. No.: 18/693,761

(22) PCT Filed: Aug. 18, 2022
(86) PCT No.: PCT/CN2022/113301

§ 371 Date: Mar. 20, 2024

(30) Foreign Application Priority Data
Oct. 12, 2021 (CN) 202111188227.X

(51) Int. Cl. B60H 1/24; B29C 45/14; B29L 31/00; B29L 31/34; B29L 31/36; B60N 2/56; F04D 25/08

(52) U.S. Cl. CPC B60H 1/246; B29C 45/14065; B29C 45/14426; F04D 25/08; B29C 2045/14139; B29C 2045/1486; B29C 2045/14868; B29L 2031/3481; B29L 2031/36; B29L 2031/771; B60N 2/56

(57) ABSTRACT

A blower for a vehicle seat or a vehicle power battery system, the blower includes a motor; a control device, which is electrically connected to the motor to control operation of the motor; a housing, within which the control device is disposed; and an electrical connector having a plurality of pins, the plurality of pins each having inner end portions located inside the housing and outer end portions exposed outside the housing, the inner end portions being electrically connected to the control device; during a molding process of a housing part of the housing, at least a portion of the electrical connector is integrally formed on the housing part.

### TECHNICAL FIELD

The present invention relates to a blower for a vehicle seat or vehicle power battery system, a corresponding ventilation device for a vehicle seat or vehicle power battery system, a corresponding vehicle seat or vehicle power battery system, a corresponding method for manufacturing a blower and corresponding manufacturing equipment for implementing the method.

### BACKGROUND

With the development of technology and people's increasing requirements for comfort, more and more vehicle seats are equipped with ventilation devices in order to improve the air circulation of the contact area between the body and the seat surface, so that the contact area between the body and the seat can remain dry and comfortable even after a long car ride. In addition, with the popularization and development of gasoline-electric hybrid and pure electric technologies, the requirements for the heat dissipation performance of vehicle power batteries are also increasing.

The performance and cost of a blower, as an important part of the ventilation device, are of vital importance. A control device for controlling the operation of the blower, such as a printed circuit board assembly, is usually provided in a housing, and the control device needs to be electrically connected to an external device through a connecting device in order to communicate with and receive power from the external device.

At present, connecting devices are mainly in the following two forms: 1) a separate connector mounted on the printed circuit board assembly or fixedly connected in other ways to the printed circuit board assembly. As the connector is fixedly connected to the printed circuit board assembly, the movement of the connector will bring the printed circuit board assembly to move along with it, which may cause damage to the printed circuit board assembly when plugging and unplugging the connector; and 2) a wire harness drawn out of the housing, with one end of the wire harness electrically connected to the printed circuit board assembly and the other end thereof equipped with a plug connector. This is a complicated and less reliable manner, and there are certain problems in the arrangements of the wiring harness.

Moreover, the cost is relatively high and the manufacturing is complicated in either form.

For this reason, the existing connecting devices need to be improved.

### BRIEF SUMMARY OF THE INVENTION

The object of the invention is to provide an improved blower for a vehicle seat or vehicle power battery system, a corresponding ventilation device for a vehicle seat or vehicle power battery system, a corresponding vehicle seat or vehicle power battery system, a corresponding method for manufacturing a blower, and corresponding manufacturing equipment for implementing the method.

According to a first aspect of the invention, a blower for a vehicle seat or vehicle power battery system is provided, comprising: a motor; a control device, which is electrically connected to the motor to control operation of the motor; a housing, within which the control device is disposed; and an electrical connector having a plurality of pins, the pins each having an inner end portion located inside the housing and an outer end portion exposed outside the housing, the inner end portions being electrically connected to the control device; wherein during a molding process of a housing part of the housing, at least a portion of the electrical connector is integrally formed on the housing part.

According to an optional embodiment of the invention, the electrical connector is configured as a plug-in connector; and/or the control device is configured as a printed circuit board assembly; and/or the housing part is injection molded.

According to an optional embodiment of the invention, a stator of the motor is fixedly mounted to the control device; and/or the inner end portions are electrically connected directly to the control device.

According to an optional embodiment of the invention, the inner end portions are plugged into electrical connecting holes of the control device; and/or at least a section of an intermediate portion of the pin located between the inner end portion and the outer end portion can be exposed from an outer side of the housing to provide test electrical contacts for testing the blower; and/or at least a section of an intermediate portion of the pin located between the inner end portion and the outer end portion is exposed on an inner side of the housing.

According to an optional embodiment of the invention, the control device is fixed to an inner side of the housing part, and the electrical connector as a whole is integrally formed on the housing part; and/or the plurality of pins are arranged side by side; and/or the inner end portions of the plurality of pins are bent to expand laterally outwards so as to increase gaps between the inner end portions.

According to an optional embodiment of the invention, the electrical connector is formed at a periphery of the housing; and/or the inner end portion is electrically connected to the control device by soldering; and/or at least a portion of the inner end portion extends axially; and/or at least a portion of the electrical connector extends radially.

According to a second aspect of the invention, a ventilation device for a vehicle seat or vehicle power battery system is provided, and the ventilation device comprises the blower.

According to a third aspect of the invention, a vehicle seat or vehicle power battery system is provided, and the vehicle seat or vehicle power battery system comprises the ventilation device.

According to a fourth aspect of the invention, a method for manufacturing the blower is provided, and the method at least comprises steps S1 and S2. In step S1, at least one of the plurality of pins is arranged in a mold for molding the housing part. In step S2, the housing part is molded with the mold so as to integrally form at least a portion of the electrical connector on the housing part.

According to an optional embodiment of the invention, in step S1, the plurality of pins are arranged in the mold; and/or in step S2, the electrical connector as a whole is integrally formed on the housing part.

According to an optional embodiment of the invention, in step S1, the plurality of pins are combined by a bonding structure into an integral component, which is then arranged in the mold; and/or in step S1, the plurality of pins are held with a holding structure in the mold, in order to hold the plurality of pins stably in position during a molding process of the housing part.

According to an optional embodiment of the invention, the integral component is manufactured by punching and/or injection molding, and the bonding structure comprises connecting structures connected between adjacent pins.

According to an optional embodiment of the invention, the method further comprises step S3 in which, after step S2, the plurality of pins are separated so as to be electrically isolated from each other.

According to an optional embodiment of the invention, in step S3, the bonding structure exposed from the inner side of the housing is cut to separate the plurality of pins.

According to an optional embodiment of the invention, the method further comprises the following steps: step S4, in which the pins are electrically connected directly to the control device; and/or step S5, in which the blower is tested by mean of test electrical contacts formed by at least a section, exposed outside the housing, of the intermediate portion of the pins located between the inner end portions and the outer end portions.

According to an optional embodiment of the invention, the method further comprises step S6, in which after the test is completed, an insulating material is used to seal the test electrical contacts.

According to a fifth aspect of the invention, a manufacturing equipment for implementing the method is provided, comprising: a conveyor table, on which the mold is placed; a placing station, which is used for performing step S1; and a molding station, which is used for performing step S2.

According to an optional embodiment of the invention, the conveyor table is configured as a rotary conveyor table; and/or the manufacturing equipment further comprises a separating station for separating the plurality of pins to electrically isolate the plurality of pins from each other.

According to some embodiments of the invention, the blower is simple in structure, and it provides reliable performance at a relatively low cost.

### BRIEF DESCRIPTION OF THE DRAWINGS

The principles, characteristics and advantages of the present invention can be better understood by describing the invention in more detail with reference to the accompanying drawings:

FIG. 1 shows an exploded perspective view of part of a blower for a vehicle seat or vehicle power battery system according to an exemplary embodiment of the invention.

FIG. 2 shows a perspective view observed from another angle of the part of the blower of FIG. 1 after being assembled.

FIG. 3 shows a flowchart of a method for manufacturing a blower according to an exemplary embodiment of the invention.

FIGS. 4, 5 and 6 show schematic illustrations of a method for manufacturing a blower according to an exemplary embodiment of the invention.

FIG. 7 shows a schematic illustration of a manufacturing equipment for implementing a method for manufacturing a blower.

### DETAILED DESCRIPTION OF THE INVENTION

For a clearer understanding of the technical problem to be solved, technical solutions and advantageous technical effects of the present invention, the invention will be further elaborated in conjunction with the drawings and a number of exemplary embodiments. It is to be understood that the specific embodiments described herein are only for the purpose of explaining the invention, rather than limiting the scope of the invention.

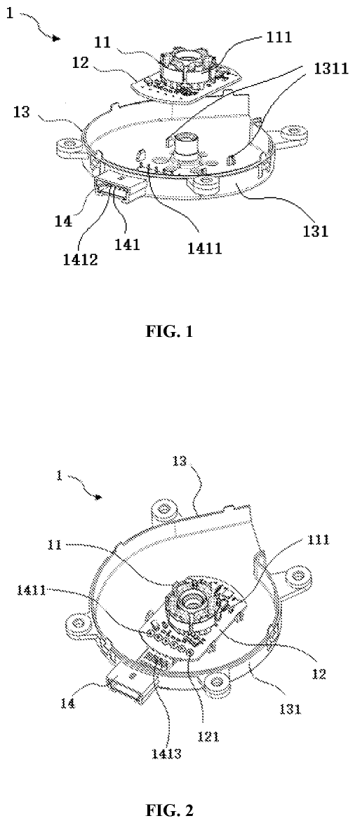

FIG. 1 shows an exploded perspective view of part of a blower for a vehicle seat or vehicle power battery system according to an exemplary embodiment of the invention. FIG. 2 shows a perspective view observed from another angle of the part of the blower of FIG. 1 after being assembled. The blower is used for generating pressurized gas and thus serves as an air source in a ventilation device of the vehicle seat or as a heat sink in the vehicle power battery system. For the sake of clarity, only the parts closely related to the present invention are shown in FIGS. 1 and 2.

As shown in FIGS. 1 and 2, the blower 1 comprises: a motor 11 (only part of which is shown here); a control device 12, which is electrically connected to the motor 11 to control operation of the motor 11; a housing 13 (likewise, only part of which is shown here), within which the control device 12 is disposed; and an electrical connector 14 having a plurality of pins 141, the pins 141 each having an inner end portion 1411 located inside the housing 13 and an outer end portion 1412 exposed outside the housing 13, the inner end portions being electrically connected to the control device 12; wherein during a molding process of a housing part 131 of the housing 13, at least a portion of the electrical connector 14 is integrally formed on the housing part 131. The electrical connector 14 is used for electrically connecting the control device 12 of the blower 1 to a corresponding external device.

The housing 13 of the blower 1 may be composed of multiple parts but, as mentioned above, only part of the housing 13 is shown in FIGS. 1 and 2. The blower 1 may be configured as a centrifugal fan.

Preferably, the housing 13 of the blower 1 generally consists mainly of two housing halves that can be assembled to each other, such as by but not limited to snap-fit connection. As shown in FIGS. 1 and 2, the housing part 131 may be configured as a housing half (a bottom housing half).

The housing 13 is usually injection molded from plastic, which is not only easy to manufacture, but also at lower manufacturing cost.

According to an exemplary embodiment of the invention, the electrical connector 14 may be configured as a plug-in connector. Plug-in connectors can provide convenient and reliable electrical connections.

As shown in FIGS. 1 and 2, the pins 141 of the plug-in connector may be configured as plug pins, which are surrounded by a case of the electrical connector 14. This kind of electrical connector is quite common, and no further details will be given here. The case of the electrical connector 14 is also preferably made of plastic.

As mentioned above, at least a portion of, particularly the entire electrical connector 14 is integrally formed on the housing part 131 during a molding process of the housing part 131 of the housing 13, removing the need for separately configuring and assembling the electrical connector. In this case, since the electrical connector 14 is fixed on the housing part 131, it will not bring the control device 12 to move with it during plugging and unplugging, which is quite advantageous.

Although it is preferred that the entire electrical connector 14 is integrally formed on the housing part 131 during the molding process of the housing part 131, theoretically, it is also beneficial to integrally form a portion of the electrical connector 14 on the housing part 131 during the molding process of the housing part 131. For example, it can reduce the workload of installing the electrical connector. Theoretically, a portion of the electrical connector 14 is formed on one housing part and the other portion of the electrical connector 14 is formed on the other housing part, as long as the two housing parts can coordinate in an assembled state to form the electrical connector 14.

In particular, pins 141 can be embedded in the housing part 131 of the housing 13, which can be easily achieved particularly by injection molding.

According to an exemplary embodiment of the invention, the control device 12 may be configured as a printed circuit board assembly (PCBA).

As shown in FIG. 2, a stator 111 of the motor 11 may be fixedly mounted to the control device 12. Particularly when the control device 12 is a printed circuit board assembly, the stator 111 of the motor 11 can be fixed on the printed circuit board assembly by inserting plug pins into connecting holes (preferably through holes) of the printed circuit board assembly. Preferably, such plug-in connection can also provide an electrical connection between the stator 111 of the motor 11 and the printed circuit board assembly.

In order to ensure the reliability of the connection, it is also possible to apply a solder to the position of insertion for soldering or use processes such as contact welding.

According to an exemplary embodiment of the invention, the inner end portions 1411 are electrically connected directly to the control device 12. This means that the inner end portions 1411 directly extend to the control device 12 and an electrical connection with the control device 12 is established through the inner end portions 1411 themselves, in which case no additional electrical connection elements, such as wires, are required between the inner end portions 1411 and the control device 12, thereby facilitating the connection and simplifying the design.

Similarly, as shown in FIG. 2, the inner end portions 1411 are plugged into electrical connecting holes 121 of the control device 12. Additionally or alternatively, the inner end portions 1411 may also be electrically connected to the control device 12 by soldering. Preferably, soldering is performed after plug-in connection, so that the reliability can be greatly improved.

According to an exemplary embodiment of the invention, at least a section of an intermediate portion 1413 of the pins 141 located between the inner end portions 1411 and the outer end portions 1412 can be exposed from an outer side of the housing 13 in order to provide test electrical contacts for testing the blower 1. In FIGS. 1 and 2, as the exposed section is located underside (outside) of the housing part 131, it is not visible in the drawings.

As shown in FIG. 2, according to an exemplary embodiment of the invention, at least a section of the intermediate portion 1413 is exposed on an inner side of the housing 13. Such exposure facilitates separation of adjacent pins 141, thereby ensuring that no electrical short circuit occurs between the pins 141, in particular when multiple pins 141 are initially formed as a whole in the housing part 131. This can more easily understood in conjunction with the following description of the manufacturing process of the blower 1.

As shown in FIGS. 1 and 2, the control device 12 is arranged on the inner side of the housing part 131 and may, for example, be positioned through a guide structure 1311 provided inside the housing part 131 and then fixed or connected, for example, through other structures. The guide structure 1311 may also be integrally formed during the molding process of the housing part 131.

According to an exemplary embodiment of the invention, the plurality of pins 141 are arranged side by side.

According to an exemplary embodiment of the invention, the inner end portions 1411 of the plurality of pins 141 are bent to expand laterally outwards so as to increase gaps between the inner end portions 1411, which facilitates reliable connection of the pins to the control device 12. This can be clearly seen from the drawing given below illustrating the manufacturing process of the blower 1.

As shown in FIGS. 1 and 2, according to an exemplary embodiment of the invention, the electrical connector 14 is formed at a periphery of the housing 13. Preferably, at least a portion of the electrical connector 14, in particular the portion located outside the housing 13 extends radially outward.

According to an exemplary embodiment of the invention, at least a portion of the inner end portion 1411 may extend axially, which can be realized by bending, so as to be easily inserted into the electrical connecting hole 121 of the control device 12 for establishing connection. The axial direction is referred to relative to an axis of rotation of the motor 11.

Next, a corresponding manufacturing process (including the assembly process) of the blower 1 shown in FIGS. 1 and 2 will be described.

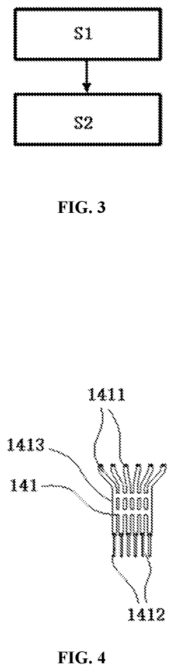

FIG. 3 shows a flowchart of a method for manufacturing a blower 1 according to an exemplary embodiment of the invention.

As shown in FIG. 3, the method comprises at least steps S1 and S2. In step S1, at least one of a plurality of pins 141 is arranged in a mold for molding the housing part 131. In step S2, the housing part 131 is molded by the mold so as to integrally form at least a portion of the electrical connector 14 on the housing part 131.

FIGS. 4, 5 and 6 show schematic illustrations of a method for manufacturing a blower 1 according to an exemplary embodiment of the invention.

FIG. 4 shows a plurality of pins 141. In this exemplary embodiment, the plurality of pins 141 are combined into a whole, so that the plurality of pins 141 can be easily arranged together in the mold, and this combination allows the plurality of pins 141 to be held in place by a fixed relative position, so that no displacement of the pins 141 occurs during the molding process of the housing part 131.

In order to hold the plurality of pins 141 together, the plurality of pins 141 may be combined into an integral component by a bonding structure.

According to an exemplary embodiment of the invention, the integral component is manufactured by punching and/or injection molding, and the bonding structure comprises connecting structures connected between adjacent pins 141. In this case, it is possible to form the integral component shown in FIG. 4 by punching an electrically conductive sheet material, such as a copper sheet. This method is simple and reliable, but it requires a subsequent separation operation. It is also possible to form the punching-separated pins into one piece by molding.

It is also conceivable for those skilled in the art that the bonding structure may be embodied in other manners, for example, bonding by using an adhesive. In this case, an insulator may be selected as the adhesive, but it must be ensured that it will not be damaged during the molding process of the housing part 131 and it can be well combined with the molding material.

As another possible embodiment, the plurality of pins 141 may also be held in the mold by a holding structure provided in the mold in order to be stably held in position during the molding process of the housing part 131. The holding structure may be provided on the mold.

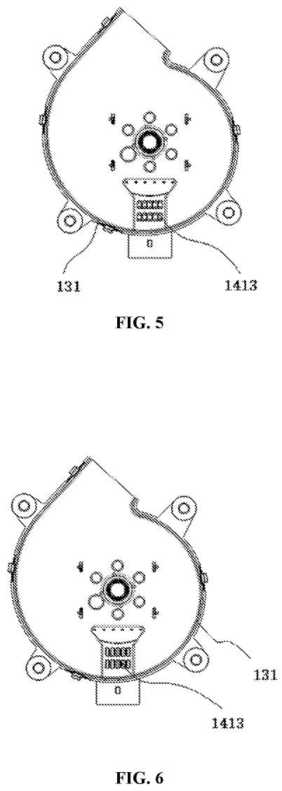

FIG. 5 shows, with a top view of the inner side of the housing part 131, a situation in which the electrical connector 14 is integrally formed in the housing part 131 after molding of the housing part 131.

As shown in FIG. 5, the electrical connector 14 is integrally formed on the housing part 131, and preferably a section of the intermediate portion 1413 of the plurality of pins 141 is exposed on the inner side of the housing part 131. Preferably, the bonding structure may also be exposed.

FIG. 6 shows a situation in which the plurality of pins 141 are separated and thus are electrically isolated from each other. In this case, electrical connections, for example, the bonding structures, between the plurality of pins 141 are damaged.

According to an exemplary embodiment of the invention, the separating operation may be performed by cutting.

A skilled person in the art can understand that the method may further comprise: electrically connecting the pins 141 directly to the control device 12.

According to an exemplary embodiment of the invention, the method may further comprise: testing the blower 1 by mean of test electrical contacts formed by at least a section, exposed outside the housing 13, of the intermediate portion 1413. In this way, there is no need to plug or unplug the electrical connector 14 during the test, thereby reducing the number of times of plugging and unplugging the electrical connector 14 and prolonging its service life.

According to an exemplary embodiment of the invention, after the test is completed, an insulating material, such as an insulating sealing tape, may be used to seal the test electrical contacts. With the sealing by the tape, the test may be performed by tearing off the tape when needed.

Some other assembling steps can be easily understood by referring to the above description, thus, no further details will be given here.

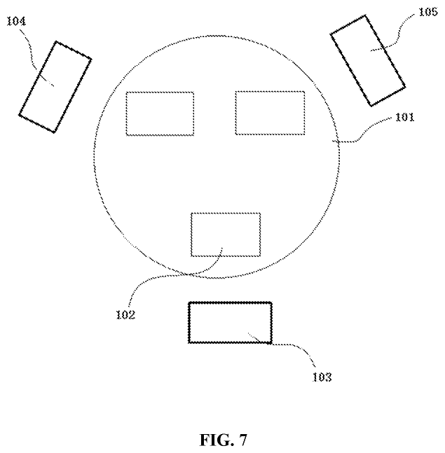

FIG. 7 shows a schematic illustration of a manufacturing equipment for implementing a method for manufacturing a blower 1. As shown in FIG. 7, the manufacturing equipment 100 comprises: a conveyor table 101, on which a mold 120 is placed; a placing station 103, which is used for performing step S1; and a molding station 104, which is used for performing step S2. As shown in FIG. 7, the conveyor table 101 may be configured preferably as a rotary conveyor table which, for example, can rotate in clockwise direction in FIG. 7.

As shown in FIG. 7, according to an exemplary embodiment of the invention, the manufacturing equipment 100 further comprises a separating station 105 for separating the plurality of pins 141 to electrically isolate the plurality of pins 141 from each other.

While specific embodiments of the invention have been described in detail herein, they are for the purpose of explanation only and should not be construed as limitations of the scope of the invention. Various substitutions, changes and modifications can be devised without departing from the spirit and scope of the invention.

1. A blower for a vehicle seat or a vehicle power battery system, comprising:
a motor
a control device, which is electrically connected to the motor to control operation of the motor;
a housing, within which the control device is disposed; and
an electrical connector having a plurality of pins, the plurality of pins each having inner end portions located inside the housing and outer end portions exposed outside the housing, the inner end portions being electrically connected to the control device;
wherein during a molding process of a housing part of the housing, at least a portion of the electrical connector is integrally formed on the housing part.

2. The blower according to claim 1, wherein,
the electrical connector is configured as a plug-in connector; and/or
the control device is configured as a printed circuit board assembly; and/or
the housing part is injection molded.

3. The blower according to claim 1, wherein,
a stator of the motor is fixedly mounted to the control device; and/or
the inner end portions are electrically connected directly to the control device.

4. The blower according to claim 1, wherein,
the inner end portions are plugged into electrical connecting holes of the control device; and/or
at least a section of an intermediate portion of the plurality of pins located between the inner end portions; and the outer end portions are exposed from an outer side of the housing to provide test electrical contacts for testing the blower; and/or
at least a section of an intermediate portion of the plurality of pins located between the inner end portions and the outer end portions is exposed on an inner side of the housing.

5. The blower according to claim 1, wherein,
the control device is fixed to an inner side of the housing part, and the electrical connector as a whole is integrally formed on the housing part; and/or
the plurality of pins are arranged side by side; and/or
the inner end portions of the plurality of pins are bent to expand laterally outwards, so as to increase gaps between the inner end portions.

6. The blower according to claim 1, wherein,
the electrical connector is formed at a periphery of the housing; and/or
the inner end portions are electrically connected to the control device by soldering; and/or
at least a portion of the inner end portions extend axially; and/or
at least a portion of the electrical connector extends radially.

7. A ventilation device for the vehicle seat or the vehicle power battery system, wherein the ventilation device comprises the blower according to claim 1.

8. The vehicle seat or the vehicle power battery system, wherein the vehicle seat or the vehicle power battery system comprises the ventilation device according to claim 7.

9. A method for manufacturing the blower according to claim 1, the method at least comprising the following steps:
step S1: arranging at least one of the plurality of pins in a mold for molding the housing part; and
step S2: molding the housing part with the mold, so as to integrally form at least a portion of the electrical connector on the housing part.

10. The method according to claim 9, wherein,
in step S1, the plurality of pins are arranged in the mold; and/or
in step S2, the electrical connector as a whole is integrally formed on the housing part.

11. The method according to claim 10, wherein,
in step S1, the plurality of pins are combined by a bonding structure into an integral component, which is then arranged in the mold; and/or
in step S1, the plurality of pins are held with a holding structure in the mold, in order to hold the plurality of pins stably in position during a molding process of the housing part.

12. The method according to claim 11, wherein,
the integral component is manufactured by punching and/or injection molding, and the bonding structure comprises connecting structures connected between adjacent pins.

13. The method according to claim 12, wherein the method further comprises the following step:
step S3: after step S2, separating the plurality of pins to electrically isolate the plurality of pins from each other.

14. The method according to claim 13, wherein,
in step S3, the bonding structure that is exposed from the inner side of the housing is cut to separate the plurality of pins.

15. The method according to claim 9, wherein the method further comprises the following steps:
step S4: electrically connecting the pins directly to the control device; and/or
step S5: testing the blower by test electrical contacts formed by at least a section, exposed outside the housing, of the intermediate portion of the pins located between the inner end portions and the outer end portions.

16. The method according to claim 15, wherein the method further comprises the following step:
step S6: after the test is completed, using an insulating material to seal the test electrical contacts.

17. A manufacturing equipment for implementing the method according to claim 9, comprising:
a conveyor table, on which the mold is placed;
a placing station, which is used for performing the step S1; and
a molding station, which is used for performing the step S2.

18. The manufacturing equipment according to claim 17, wherein,
the conveyor table is configured as a rotary conveyor table; and/or
the manufacturing equipment further comprises a separating station for separating the plurality of pins to electrically isolate the plurality of pins from each other.
